(19) United States
(12) Patent Application Publication
(10) Pub. No.: US 2013/0085249 A1
(43) Pub. Date: Apr. 4, 2013

(54) CONJUGATED POLYMER BASED ON PERYLENE TETRACARBOXYLIC ACID DIIMIDE AND DIBENZOTHIOPHENE AND THE PREPARATION METHOD AND APPLICATION THEREOF

(71) Applicants: Mingjie Zhou, Guangdong (CN); Jie Huang, Guangdong (CN); Rong Guan, Guangdong (CN)

(72) Inventors: Mingjie Zhou, Guangdong (CN); Jie Huang, Guangdong (CN); Rong Guan, Guangdong (CN)

(73) Assignee: OCEAN'S KING LIGHTING SCIENCE &TECHNOLOGY CO., LTD, GUANGDONG (CN)

(21) Appl. No.: 13/702,141

(22) PCT Filed: Jun. 9, 2010
(86) PCT No.: PCT/CN2010/073727

§ 371 Date: Dec. 5, 2012

(51) Int. Cl. C08G 61/12

(52) U.S. Cl. CPC C08G 61/126
USPC 528/9

(57) ABSTRACT

The present invention discloses a conjugated polymer having high photoelectric conversion efficiency based on perylene tetracarboxylic acid diimide and dibenzothiophene having high light absorption and high electron affinity in the visible light region, which has the following general formula:

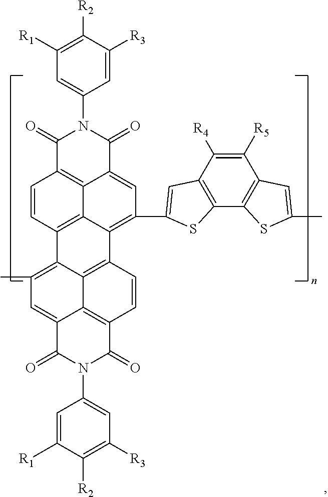

wherein: n is a positive integer less than 101; R1, R2 and R3 are a hydrogen, a C1-C20 alkyl and a C1-C20 alkoxy phenyl or phenyl; and R4 and R5 are a C1-C20 alkyl. This conjugated polymer, having good solubility, strong absorbance and wide light absorption range, as well as improved photoelectric conversion efficiency and good charge transfer performance, can widely be applied to the field of photoelectric energy conversion, such as solar cells, organic electroluminescent devices and organic field effect transistors, having good market prospects. The present invention further provides a method of preparing the conjugated polymer.

### FIELD OF THE INVENTION

The present invention relates to the optoelectronic field, and particularly relates to a conjugated polymer based on perylene tetracarboxylic acid diimide and dibenzothiophene and the preparation method thereof.

### BACKGROUND OF THE INVENTION

Using cheap materials for preparation of the solar cell having low cost and high efficiency has been the research hotspot and difficulty in the photovoltaic field. The traditional silicon solar cell used for ground has complicated production process and high cost, making its application restricted. In order to reduce the cost and expand the scope of application, people have always been looking for a new solar cell material for a long time.

The polymer solar cell has attracted a lot of attention because of such advantages as low-price raw materials, light weight, being flexible, simple production process, and enabling large-area preparation by coating, printing and other means. It will have a very huge market prospect if its energy conversion efficiency can be improved to near the level of the commercial silicon solar cell. Since N. S. Sariciftci et al. reported in 1992 in the SCIENCE (N. S Sariciftci, L. Smilowitz, A. J. Heeger, et al., Science, 1992, 258, 1474) about the photoinduced electron transfer phenomenon between the conjugated polymer and C60, people have done a great deal of research in the polymer solar cell and obtained rapid development.

The research of the polymer solar cell is focused mainly on the donor/acceptor blends; the energy conversion efficiency of the PTB7/PC71BM blends has attained 7.4% (Y. Liang et al., Adv. Mater.; DOI:10.1002/adma.200903528), but it is still much lower than that of the inorganic solar cell. There are the following main limiting factors that restrict the performance improvement: The organic semiconductor device has a relatively low carrier mobility, the device has a spectral response not matching with the solar radiation spectrum, the red light region having a high photon flux has not been used effectively, and the carrier has a low electrode collecting efficiency, etc. In order to make the polymer solar cell get actual application, it is still the priority of the research field to develop new materials and greatly improve the energy conversion efficiency.

### SUMMARY OF THE INVENTION

Accordingly, it is necessary to provide a conjugated polymer based on perylene tetracarboxylic acid diimide and dibenzothiophene that has high photoelectric conversion efficiency.

In addition, it is also necessary to provide a method of preparing the conjugated polymer based on perylene tetracarboxylic acid diimide and dibenzothiophene that has high photoelectric conversion efficiency.

A conjugated polymer based on perylene tetracarboxylic acid diimide and dibenzothiophene is provided, having the following general formula:

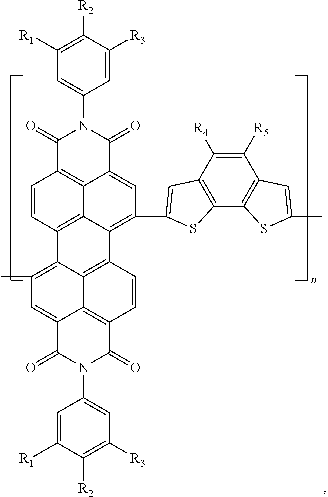

wherein: n is a positive integer less than 101; R₁, R₂ and R₃ are a hydrogen, a C₁-C₂₀ alkyl and a C₁-C₂₀ alkoxy phenyl or phenyl; and R₄ and R₅ are a C₁-C₂₀ alkyl.

A method of preparing the conjugated polymer based on perylene tetracarboxylic acid diimide and dibenzothiophene is provided, comprising the following steps:

S11: perylene tetracarboxylic acid diimide dibromide or its derivatives and an organic tin compound containing a dibenzothiophene unit are mixed and dissolved in an organic solvent at a molar ratio of 1:1 to 1.5:1; and

S12: a catalyst is added to the solution of Step S 11 under an anaerobic environment, and a Stille coupling reaction goes on at 50° C. to 120° C. for 24 to 72 hours, producing a solution of the conjugated polymer, with the reaction equation thereof as follows:

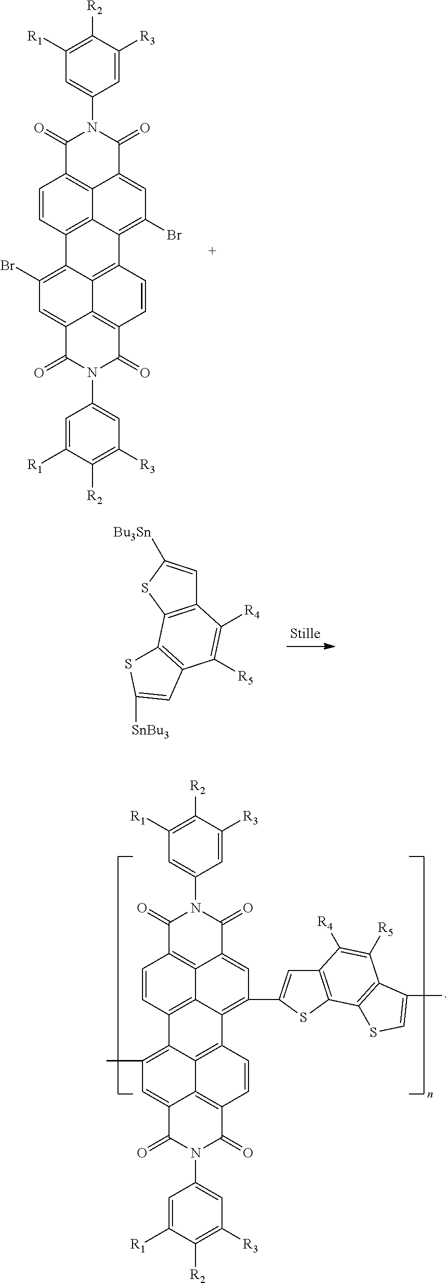

Preferably, the organic solvent in Step S11 is selected from the group consisting of tetrahydrofuran, dimethyl amide, dioxane, ethylene glycol dimethyl ether, benzene, and toluene; the catalyst in Step S12 is added in an amount from 0.01% to 5% by molar number of the total materials; the catalyst is an organic palladium or a mixture of the organic palladium and an organophosphine ligand; the organic palladium is selected from the group consisting of Pd2(dba)₃, Pd(PPh₃)₄ and Pd(PPh₃)₂Cl₂; the organophosphine ligand is P(o-Tol)₃; and a molar ratio of the organic palladium to the organophosphine ligand in the mixture thereof is from 1:2 to 1:20.

Preferably, the method of preparing the conjugated polymer further includes the purification process after the conjugated polymer solution is obtained, which comprises the following specific steps:

S13: the conjugated polymer solution is added in droplets into methanol for precipitation treatment, and then filtered, washed with methanol, and dried, producing a colloid containing the conjugated polymer; S14: the colloid containing the conjugated polymer is dissolved in toluene, then the toluene solution is added into an aqueous solution of sodium diethyldithiocarbamate, and then the resultant solution goes through an aluminum oxide column chromatography after heat agitation at 80° C. to 100° C. to isolate the conjugated polymer, and finally decompression is performed after chlorobenzene elution to remove the organic solvent; and S15: Step S13 is repeated at least once, and acetone Soxhlet is used to extract the conjugated polymer isolated in Step S14, producing a solid of the conjugated polymer.

A solar cell device prepared with the above-mentioned conjugated polymer based on perylene tetracarboxylic acid diimide and dibenzothiophene is provided, comprising the following sequentially arranged structures: a substrate, a conductive layer, a poly(3,4-ethylenedioxythiophene)/poly(styrenesulfonate) layer, and a conjugated polymer layer having an active effect and an aluminum metal layer.

A method of manufacturing the above-mentioned solar cell device is provided, comprising the following steps:

S21: the substrate is cleaned, and then a surface thereof is deposited with a conductive layer;

S22: the conductive layer is surface treated and is coated with poly(3,4-ethylenedioxythiophene)/poly(styrenesulfonate) to form a poly(3,4-ethylenedioxythiophene)/poly(styrenesulfonate) layer;

S23: the poly(3,4-ethylenedioxythiophene)/poly(styrenesulfonate) layer is coated with the conjugated polymer to form a conjugated polymer layer having an active effect; and

S24: an aluminum metal layer is formed on the conjugated polymer layer, producing the solar cell device.

An organic electroluminescent device prepared with the above-mentioned conjugated polymer based on perylene tetracarboxylic acid diimide and dibenzothiophene is provided, comprising the following sequentially arranged structures: a substrate, a conductive layer, a conjugated polymer layer having luminescent property, a LiF buffer layer and an aluminum metal layer.

A method of preparing the above-mentioned organic electroluminescent device is provided, comprising the following steps:

S31: the substrate is cleaned, and then one surface of it is coated with a conductive layer;

S32: the conductive layer, after undergoing surface treatment, is coated with the conjugated polymer to form a conjugated polymer layer having a luminous effect;

S33: LiF is coated onto the conjugated polymer layer by vapor deposition, forming a LiF buffer layer; and

S34: an aluminum metal layer is provided on the LiF buffer layer, producing the organic electroluminescent device.

An organic field effect transistor prepared with the above-mentioned conjugated polymer based on perylene tetracarboxylic acid diimide and dibenzothiophene is provided, comprising the following sequentially arranged structures: a doped silicon substrate, a SiO₇ insulating layer, an octadecyltrichlorosilane layer, a conjugated polymer organic semiconductor layer, and metal source and drain electrodes.

A method of preparing the above-mentioned field effect transistor is provided, comprising the following steps:

S41: the doped silicon substrate is cleaned, and coated with the SiO₂ insulating layer having an insulating effect;

S42: the SiO₂ insulate layer is coated with octadecyltrichlorosilane to form an octadecyltrichlorosilane layer;

S43: the octadecyltrichlorosilane layer is coated with the conjugated polymer to form a conjugated polymer organic semiconductor layer; and

S44: the metal source and drain electrodes are provided on the conjugated polymer organic semiconductor layer, producing the organic field effect transistor.

Perylene tetracarboxylic acid diimide and its derivatives, having a large co-benzene-ring planar structure and a two-imine-ring structure, have strong absorption in the visible light region, high light, heat and environmental stability, and high electron affinity (low LUMO level), as well as high electron mobility along the stacking direction because of the π-π stacking between their big conjugated it bonds. Therefore, it has shown broad application prospects in a variety of fields such as the organic solar cell.

The conjugated polymer, through introduction of a substituent at the site of “bay” of perylene tetracarboxylic acid diimide and copolymerization of the perylene tetracarboxylic acid diimide monomer with other monomers, makes solubility of perylene tetracarboxylic acid diimide increased. Besides, the dibenzothiophene unit is a unit having a good planar structure and containing a backbone composed of two five-membered rings and one six-membered ring and, because of its good flatness and conjugated degree, it has very high mobility, and makes its solubility and soluble processing property improved by such modifications as introduction of an alkyl into the sites 4 and 5 on the dibenzothiophene unit. Therefore, the dibenzothiophene unit is copolymerized with perylene tetracarboxylic acid diimide to form an electron donor-acceptor structure to get the band gap of the polymer adjusted, and to push its absorption band edge toward the infrared and near infrared region to achieve higher photoelectric conversion efficiency.

This method of preparing the conjugated polymer is simple and feasible, and has a low requirement for facilities, and possesses strong practicability.

### BRIEF DESCRIPTION OF THE DRAWINGS

FIG. 1 is a structural schematic view of an embodiment of the solar cell device.

FIG. 2 is a structural schematic view of an embodiment of the organic electroluminescence device.

FIG. 3 is a structural schematic view of an embodiment of the organic field effect transistor.

### DETAILED DESCRIPTION

A purpose of the present invention is to provide a conjugated polymer based on perylene tetracarboxylic acid diimide and dibenzothiophene, which has good solubility, wide optical absorption spectrum, and high photoelectric conversion efficiency. The present invention further provides a method of preparing the conjugated polymer, and indicates application of this conjugated polymer in the optoelectronic field.

A conjugated polymer based on perylene tetracarboxylic acid diimide and dibenzothiophene is provided, having the following general formula:

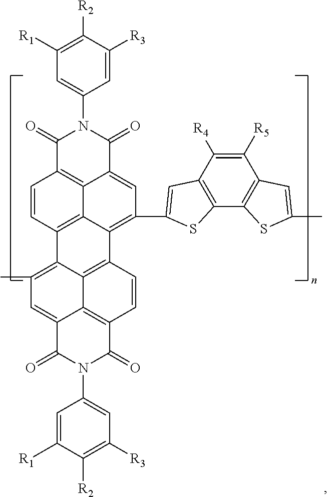

wherein: n is a positive integer less than 101; R₁, R₂ and R₃ are a hydrogen, a C₁-C₂₀ alkyl and a C₁-C₂₀ alkoxy phenyl or phenyl; and R4 and R5 are a C₁-C₂₀ alkyl.

A method of preparing the conjugated polymer based on perylene tetracarboxylic acid diimide and dibenzothiophene is provided, comprising the following steps:

S11: perylene tetracarboxylic acid diimide dibromide or its derivatives and an organic tin compound containing a dibenzothiophene unit are mixed and dissolved in an organic solvent at a molar ratio of 1:1 to 1.5:1.

S12: a catalyst is added to the solution of Step S11 under an anaerobic environment, and a Stille coupling reaction is performed at 50° C. to 120° C. for 24 to 72 hours to produce a solution of the conjugated polymer, with a reaction equation thereof as follows:

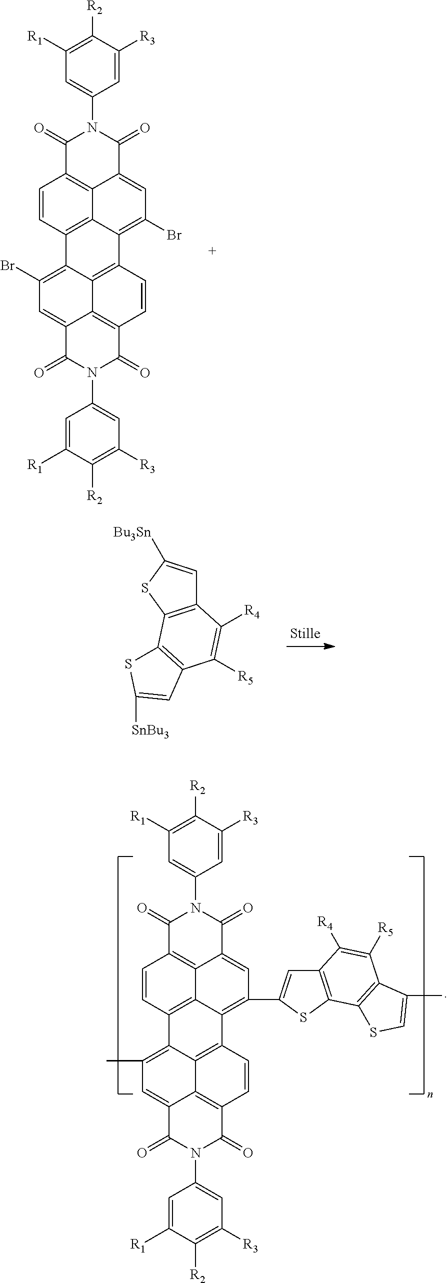

Preferably, the organic solvent in Step S11 is selected from the group consisting of tetrahydrofuran, dimethyl amide, dioxane, ethylene glycol dimethyl ether, benzene and toluene; the anaerobic environment in Step S12 is composed of nitrogen or inert gases; the catalyst is added in an amount from 0.01% to 5% by molar number of the total materials; the catalyst is an organic palladium or a mixture of the organic palladium and an organophosphine ligand; the organic palladium is selected from the group consisting of Pd₂(dba)₃, Pd(PPh₃)₄ and Pd(PPh₃)₂Cl₂; the organophosphine ligand is P(o-Tol)₃; and a molar ratio of the organic palladium to the organophosphine ligand in the mixture thereof is from 1:2 to 1:20.

Preferably, the method of preparing the conjugated polymer further includes the purification process after the conjugated polymer solution is obtained, which comprises the following specific steps:

S13: the conjugated polymer solution is added in droplets into methanol for precipitation treatment, and then filtered, washed with methanol, and dried, producing a colloid containing the conjugated polymer; S14: the colloid containing the conjugated polymer is dissolved in toluene, then the toluene solution is added into an aqueous solution of sodium diethyldithiocarbamate, and then the resultant solution goes through an aluminum oxide column chromatography after heat agitation at 80° C. to 100° C. to isolate the conjugated polymer, and finally decompression is performed after chlorobenzene elution to remove the organic solvent; and S15: Step S13 is repeated at least once, and acetone Soxhlet is used to extract the conjugated polymer isolated in Step S14, producing a solid of the conjugated polymer.

This method of preparing the conjugated polymer is simple and feasible, has a low requirement for facilities, and possesses strong practicability.

The conjugated polymer has the widespread application prospect in the photoelectric field, such as the solar cell device, the organic electroluminescent device and the organic field effect transistor.

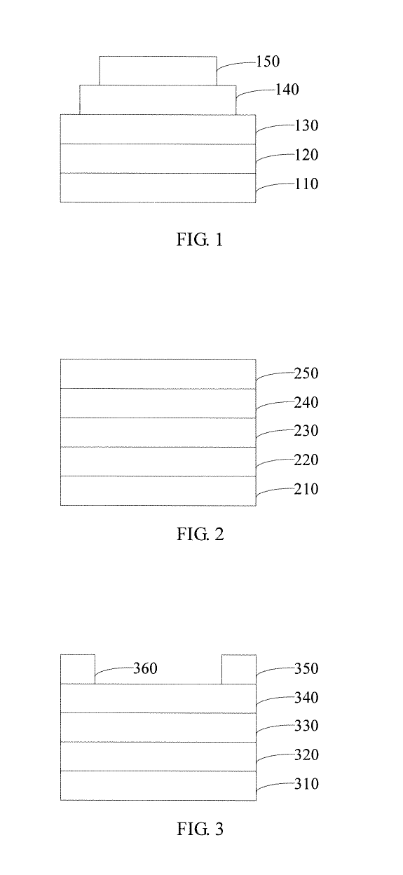

A solar cell device as shown in FIG. 1 comprises the following sequentially arranged structures: a substrate 110, a conductive layer 120, a poly(3,4-ethylenedioxythiophene)/poly(styrenesulfonate) layer 130, a conjugated polymer layer 140 having an active effect and prepared with the above conjugated polymer, and an aluminum metal layer 150.

A method of manufacturing the above-mentioned solar cell device is provided, comprising the following steps:

S21: the substrate is cleaned, and then one surface of it is deposited with a conductive layer;

S22: the conductive layer is surface treated and then coated with poly(3,4-ethylenedioxythiophene)/poly(styrenesulfonate) to form a poly(3,4-ethylenedioxythiophene)/poly(styrenesulfonate) layer;

S23: the poly(3,4-ethylenedioxythiophene)/poly(styrenesulfonate) layer is coated with the conjugated polymer to form a conjugated polymer layer having an active effect; and

S24: an aluminum metal layer is provided on the conjugated polymer layer to produce the solar cell device.

In a preferred embodiment, an ITO glass (indium-tin oxide glass) is used as the base of the substrate, glass is used as the substrate, the indium-tin oxide having a square resistance of 10-20 Ω/sq is used as the conductive layer, an oxygen-plasma treatment is adopted in the surface treatment process in Step S22, and the conjugated polymer is coated onto the poly(3,4-ethylenedioxythiophene)/poly(styrenesulfonate) layer by the spincoating technique.

An organic electroluminescent device as shown in FIG. 2 comprises the following sequentially arranged structures: a substrate 210, a conductive layer 220, a conjugated polymer layer 230 having luminescent property and prepared with the above conjugated polymer, a LiF buffer layer 240, and an aluminum metal layer 250.

A method of preparing the above-mentioned organic electroluminescent device is provided, comprising the following steps:

S31: the substrate is cleaned, and then one surface of it is deposited with a conductive layer;

S32: the conductive layer is surface treated and coated with the conjugated polymer to form a conjugated polymer layer having a luminous effect;

S33: LiF is coated onto the conjugated polymer layer by vapor deposition, forming a LiF buffer layer; and

S34: an aluminum metal layer is formed on the LiF buffer layer to produce the organic electroluminescent device.

In a preferred embodiment, an ITO glass (indium-tin oxide glass) is used as the base of the substrate, glass is used as the substrate, the indium-tin oxide having a square resistance of 10-20 Ω/sq is used as the conductive layer, an oxygen-plasma treatment is adopted in the surface treatment process in Step S22, and the conjugated polymer is coated onto the poly(3,4-ethylenedioxythiophene)/poly(styrenesulfonate) layer by the spincoating technique.

An organic field effect transistor as shown in FIG. 3 comprises the following sequentially arranged structures from bottom to top: a doped silicon substrate 310, a SiO2 insulating layer 320, an octadecyltrichlorosilane layer 330, a conjugated polymer organic semiconductor layer 340 prepared with the above conjugated polymer, and a metal source electrode 350 and a metal drain electrode 360.

A method of preparing the above-mentioned field effect transistor is provided, comprising the following steps:

S41: the doped silicon substrate is cleaned, and deposited with the SiO₂ insulating layer having an insulating effect;

S42: the SiO₂ insulate layer is coated with octadecyltrichlorosilane to form an octadecyltrichlorosilane layer;

S43: the octadecyltrichlorosilane layer is coated with the conjugated polymer to form a conjugated polymer organic semiconductor layer; and

S44: the metal source and drain electrodes are provided on the conjugated polymer organic semiconductor layer, producing the organic field effect transistor.

In a preferred embodiment, a highly-doped silicon wafer is used as the doped silicon substrate, the SiO₂ insulating layer has a thickness of 500 nm, the conjugated polymer is coated onto the octadecyltrichlorosilane layer by the spincoating technique, and the source and drain electrodes are made of gold.

The conjugated polymer of the present invention and the preparation method thereof will further be described below mainly with reference to the specific examples.

### EXAMPLE 1

Preparation of poly(N,N′-di-(3,4,5-tri-methyl phenyl)-3,4,9,10-perylene tetracarboxylic acid diimide-(4,5-dihexyl)benzo[2,1-b:3,4-b]dithiophene)

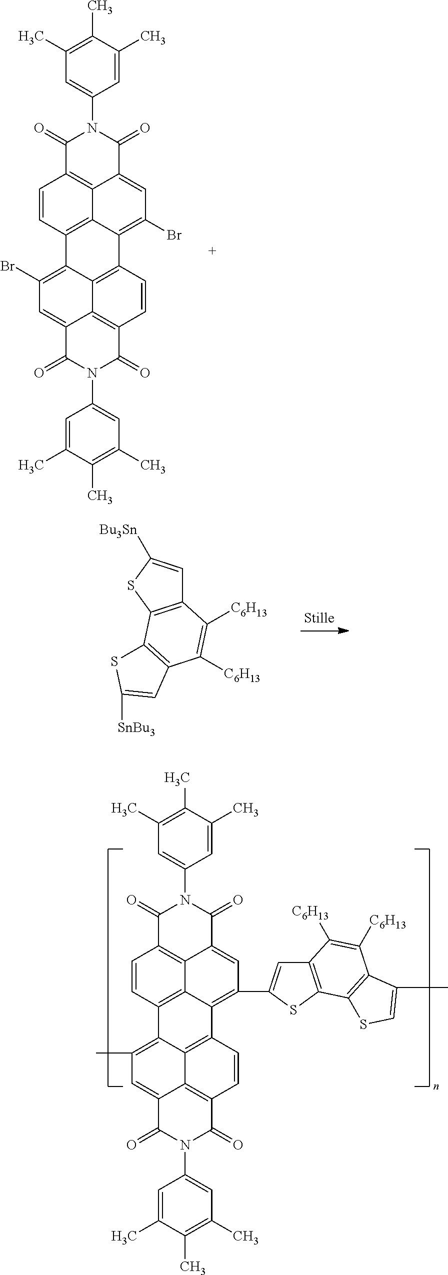

Under the protection of nitrogen, the DMF (18 mL) solution containing 0.5 mmol N,N′-di-(3,4,5-tri-methyl benzene)-1,7-dibromo-3,4,9,10-perylene tetracarboxylic acid diimide and 0.5 mmol 2,7-ditributyltin-(4,5-di-hexyl)benzo[2,1-b:3,4-b′]dithiophene was bubbled for 0.5 h to remove oxygen, then Pd₂(dba)₃ (0.14 g, 0.015 mol) and P(o-Tol)₃ (0.0083 g, 0.027 mmol) were added, and then the solution was bubbled for 0.5 h to remove the residual oxygen and then heated to 80° C. to react for 48 hours, producing a solution of the conjugated polymer. The conjugated polymer solution was added in droplets into methanol for precipitation treatment, and then filtered and dried, producing a colloid containing the conjugated polymer. The colloid containing the conjugated polymer was dissolved in toluene, then the toluene solution was added into an aqueous solution of sodium diethyldithiocarbamate, and then the resultant solution went through an aluminum oxide column chromatography after heat agitation at 90° C. to isolate the conjugated polymer, and finally decompression was performed after chlorobenzene elution to remove the organic solvent. The isolated conjugated polymer was added into methanol for precipitation treatment, and then was filtered, and washed with methanol, and acetone Soxhlet was used to extract the conjugated polymer after the drying treatment, producing a solid of the conjugated polymer. Molecular weight (GPC, THF, R. I): Mn=24,300, Mw/Mn=2.66.

### EXAMPLE 2

Preparation of poly(N,N′-di-(3,4,5-tri-methoxyphenyl)-3,4,9,10-perylene tetracarboxylic acid di imide-(4-hexyl-5-decyl)benzo[2,1-b:3,4-b]dithiophene)

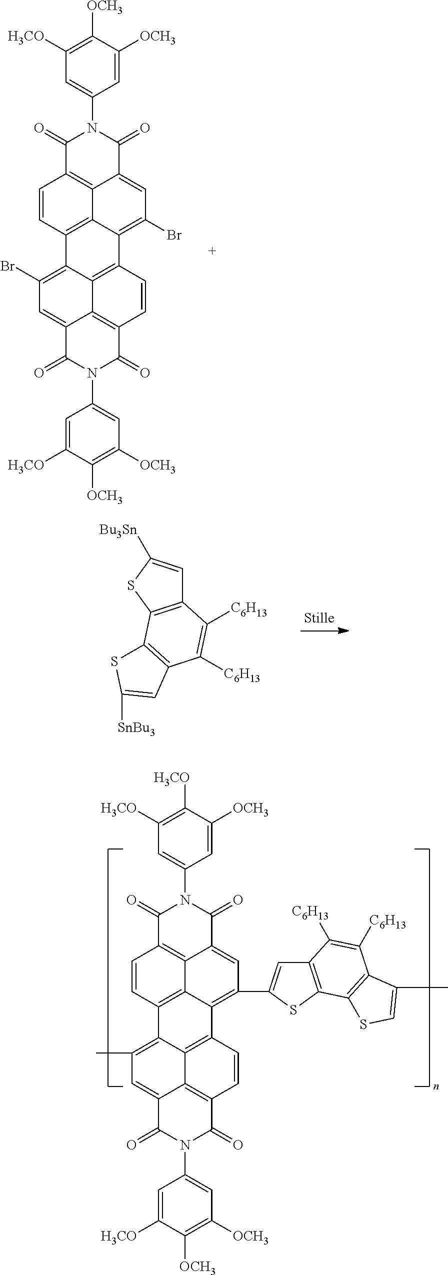

Under the protection of nitrogen, the dioxane (15 mL) solution containing 0.5 mmol N,N′-di-(3,4,5-tri-methoxyphenyl)-1,7-dibromo-3,4,9,10-perylene tetracarboxylic acid diimide and 0.5 mmol 2,7-ditributyltin-(4-hexyl-5-decyl)benzo[2,1-b:3,4-b]dithiophene was bubbled for 0.5 h to remove oxygen, then 10 mg Pd(PPh₃)₂Cl₂ was added, and then the solution was bubbled for 0.5 h to remove the residual oxygen and then heated to 85° C. to react for 36 hours, producing a solution of the conjugated polymer. The conjugated polymer solution was added in droplets into methanol for precipitation treatment, and then filtered and dried, producing a colloid containing the conjugated polymer. The colloid containing the conjugated polymer was dissolved in toluene, then the toluene solution was added into an aqueous solution of sodium diethyldithiocarbamate, and then the resultant solution went through an aluminum oxide column chromatography after heat agitation at 90° C. to isolate the conjugated polymer, and finally decompression was performed after chlorobenzene elution to remove the organic solvent. The isolated conjugated polymer was added into methanol for precipitation treatment, and then was filtered, and washed with methanol, and acetone Soxhlet was used to extract the conjugated polymer after the drying treatment, producing a solid of the conjugated polymer. Molecular weight (GPC, THF, R. I): Mn=24,200, Mw/Mn=2.57.

### EXAMPLE 3

Preparation of poly(N,N′-di-(3,4,5-tri-octyloxy phenyl)-3,4,9,10-perylene tetracarboxylic acid diimide-(4,5-di-eicosyl)benzo[2,1-b:3,4-b]dithiophene)

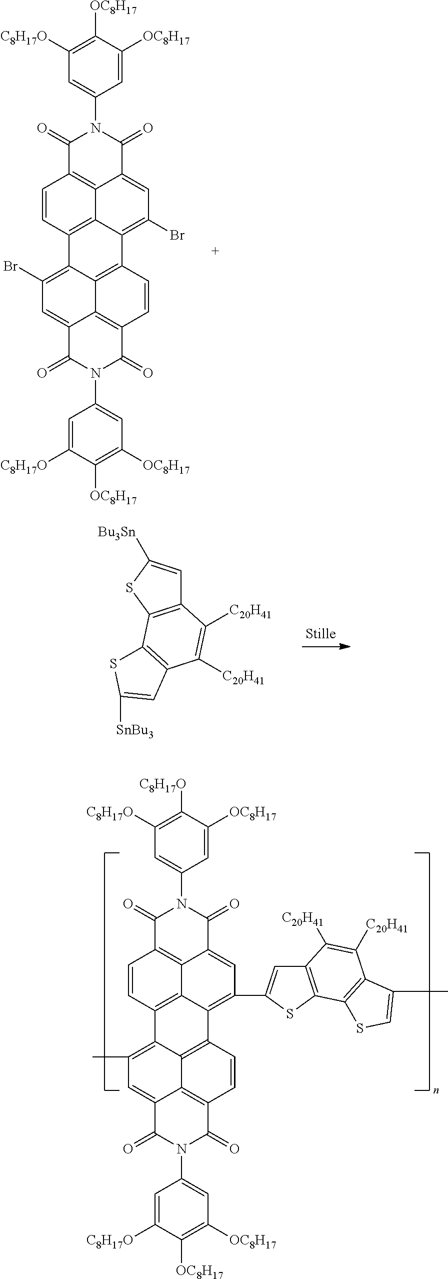

Under the protection of nitrogen, the toluene/THF (30 ml) solution containing 0.5 mmol N,N′-di-(3,4,5-tri-octyloxy phenyl)-1,7-dibromo-3,4,9,10-perylene tetracarboxylic acid diimide and 0.5 mmol 2,7-ditributyltin-(4,5-di-eicosyl)benzo[2,1-b:3,4-b′]dithiophene was bubbled for 0.5 h to remove oxygen, then 8 mg Pd(PPh₃)₄ was added, and then the solution was bubbled for 0.5 h to remove the residual oxygen and then heated to 80° C. to react for 72 hours, producing a solution of the conjugated polymer. The conjugated polymer solution was added in droplets into methanol for precipitation treatment, and then filtered and dried, producing a colloid containing the conjugated polymer. The colloid containing the conjugated polymer was dissolved in toluene, then the toluene solution was added into an aqueous solution of sodium diethyldithiocarbamate, and then the resultant solution went through an aluminum oxide column chromatography after heat agitation at 80° C. to isolate the conjugated polymer, and finally decompression was performed after chlorobenzene elution to remove the organic solvent. The isolated conjugated polymer was added into methanol for precipitation treatment, and then was filtered, and washed with methanol, and acetone Soxhlet was used to extract the conjugated polymer after the drying treatment, producing a solid of the conjugated polymer. Molecular weight (GPC, THF, R. I): Mn=22,000, Mw/Mn=2.65.

### EXAMPLE 4

Preparation of poly(N,N′-di-(3,5-di-eicosoxyl-4-methyl phenyl)-3,4,9,10-perylene tetracarboxylic acid diimide-(4,5-di-dodecyloxy)benzo[2,1-b:3,4-b′]dithiophene)

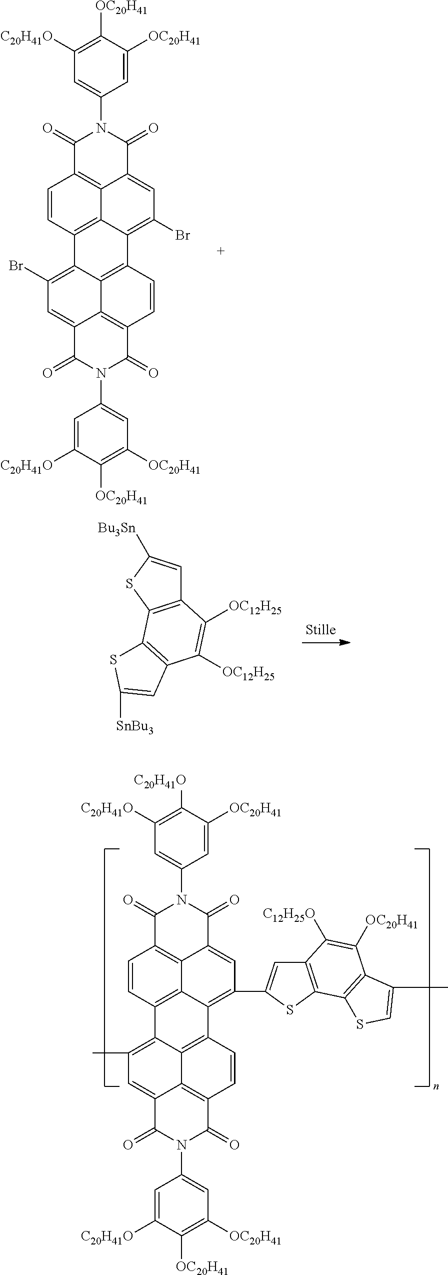

Under the protection of nitrogen, the benzene (20 mL) solution containing 0.52 mmol N,N′-di-(3,5-di-eicasoxyl-4-methyl phenyl)-1,7-dibromo-3,4,9,10-perylene tetracarboxylic acid diimide and 0.5 mmol 2,7-ditributyltin-(4,5-di-dodecyloxy)benzo[2,1-b:3,4-b]dithiophene was bubbled for 0.5 h to remove oxygen, then 5 mg Pd(PPh₃)₂Cl₂ was added, and then the solution was bubbled for 0.5 h to remove the residual oxygen and then heated to 100° C. to react for 56 hours, producing a solution of the conjugated polymer. The conjugated polymer solution was added in droplets into methanol for precipitation treatment, and then filtered and dried, producing a colloid containing the conjugated polymer. The colloid containing the conjugated polymer was dissolved in toluene, then the toluene solution was added into an aqueous solution of sodium diethyldithiocarbamate, and then the resultant solution went through an aluminum oxide column chromatography after heat agitation at 80° C. to isolate the conjugated polymer, and finally decompression was performed after chlorobenzene elution to remove the organic solvent. The isolated conjugated polymer was added into methanol for precipitation treatment, and then was filtered, and washed with methanol, and acetone Soxhlet was used to extract the conjugated polymer after the drying treatment, producing a solid of the conjugated polymer. Molecular weight (GPC, THF, R. I): Mn=25,600, Mw/Mn=3.76.

### Example 5

Preparation of poly(N,N′-di-(3,5-di-eicosoxylphenyl)-3,4,9,10-perylene tetracarboxylic acid diimide-(4-methyl-5-methoxyl)benzo[2,1-b:3,4-b]dithiophene)

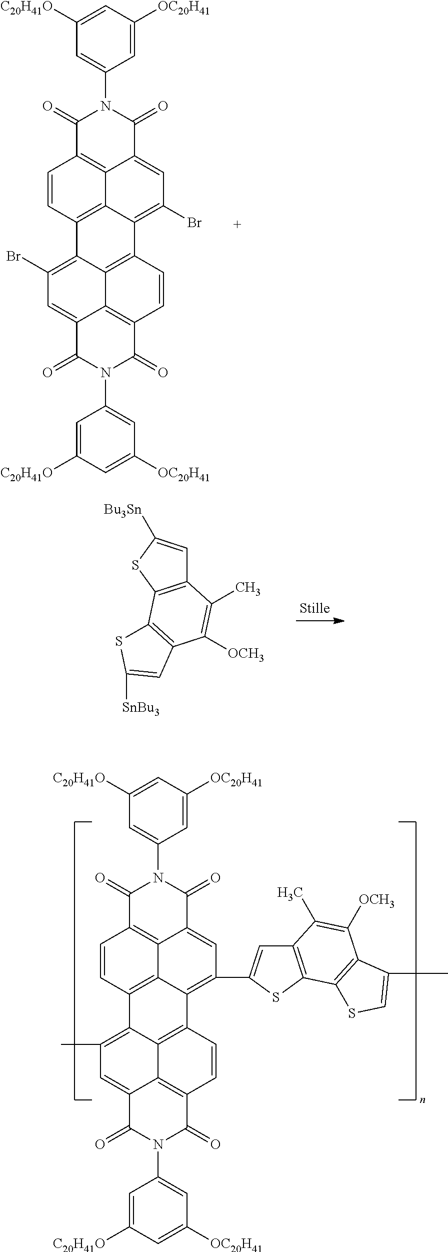

Under the protection of nitrogen, the toluene/DMF (25 ml) solution containing 0.51 mmol N,N′-di-(3,5-di-eicosoxylphenyl)-1,7-dibromo-3,4,9,10-perylene tetracarboxylic acid diimide and 0.5 mmol 2,7-ditributyltin-(4-methyl-5-methoxyl)benzo[2,1-b:3,4-b]dithiophene was bubbled for 0.5 h to remove oxygen, then 10 mg Pd(PPh3)4 was added, and then the solution was bubbled for 0.5 h to remove the residual oxygen and then heated to 70° C. to react for 40 hours, producing a solution of the conjugated polymer. The conjugated polymer solution was added in droplets into methanol for precipitation treatment, and then filtered and dried, producing a colloid containing the conjugated polymer. The colloid containing the conjugated polymer was dissolved in toluene, then the toluene solution was added into an aqueous solution of sodium diethyldithiocarbamate, and then the resultant solution went through an aluminum oxide column chromatography after heat agitation at 80° C. to isolate the conjugated polymer, and finally decompression was performed after chlorobenzene elution to remove the organic solvent. The isolated conjugated polymer was added into methanol for precipitation treatment, and then was filtered, and washed with methanol, and acetone Soxhlet was used to extract the conjugated polymer after the drying treatment, producing a solid of the conjugated polymer. Molecular weight (GPC, THF, R. I): Mn=23,300, Mw/Mn=2.44.

### EXAMPLE 6

Preparation of poly(N,N′-di-(3,4,5-tri-phenylphenyl)-3,4,9,10-perylene tetracarboxylic acid diimide-(4,4-di-eicosoxyl)benzo[2,1-b:3,4-b′ ]dithiophene)

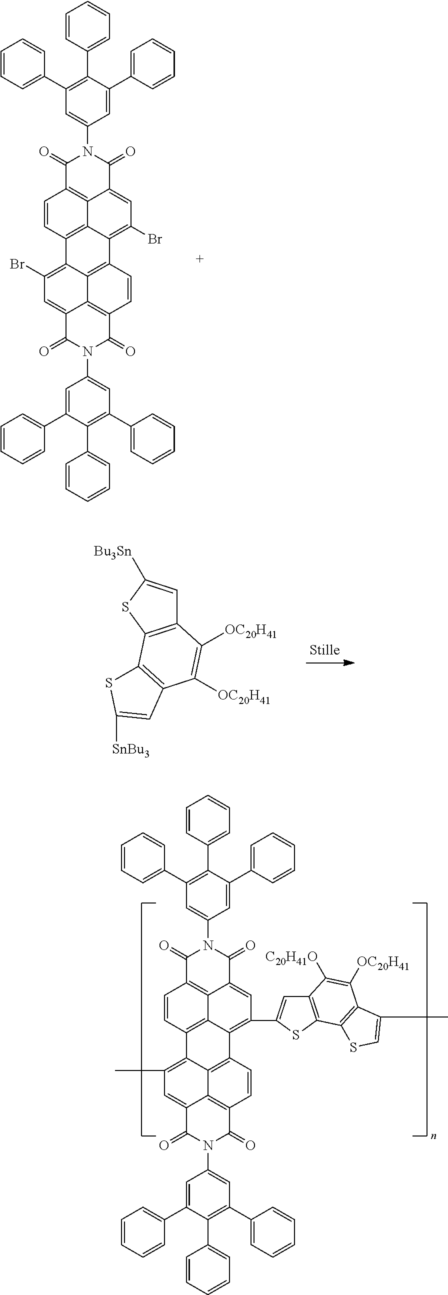

Under the protection of argon, the dioxane/THF (18 ml) solution containing 0.75 mmol N,N′-di-(3,4,5-tri-phenylphenyl)-1,7-dibromo-3,4,9,10-perylene tetracarboxylic acid diimide and 0.5 mmol 2,7-ditributyltin-(4,5-di-eicosoxyl)benzo[2,1-b:3,4-b]dithiophene was bubbled for 0.5 h to remove oxygen, then 8 mg Pd(PPh₃)₂Cl₂ was added, and then the solution was bubbled for 0.5 h to remove the residual oxygen and then heated to 65° C. to react for 72 hours, producing a solution of the conjugated polymer. The conjugated polymer solution was added in droplets into methanol for precipitation treatment, and then filtered and dried, producing a colloid containing the conjugated polymer. The colloid containing the conjugated polymer was dissolved in toluene, then the toluene solution was added into an aqueous solution of sodium diethyldithiocarbamate, and then the resultant solution went through an aluminum oxide column chromatography after heat agitation at 90° C. to isolate the conjugated polymer, and finally decompression was performed after chlorobenzene elution to remove the organic solvent. The isolated conjugated polymer was added into methanol for precipitation treatment, and then was filtered, and washed with methanol, and acetone Soxhlet was used to extract the conjugated polymer after the drying treatment, producing a solid of the conjugated polymer. Molecular weight (GPC, THF, R. 1): Mn=28,900, Mw/Mn=2.37.

Although the invention has been described in language specific to structural features and/or methodological acts, it is to be understood that the invention defined in the appended claims is not necessarily limited to the specific features or acts described. Rather, the specific features and acts are disclosed as sample forms of implementing the claimed invention.

1. A conjugated polymer based on perylene tetracarboxylic acid diimide and dibenzothiophene, having the following general formula: 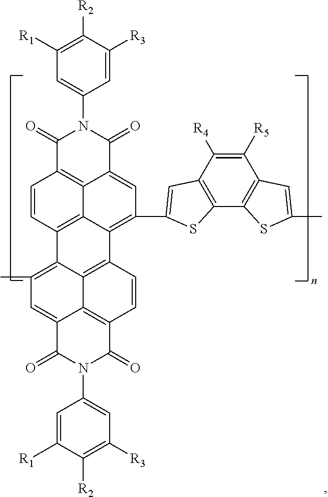
wherein: n is a positive integer less than 101;
R₁, R₂ and R₃ are a hydrogen, a C₁-C₂₀ alkyl and a C₁-C₂₀ alkoxy phenyl or phenyl; and
R₄ and R₅ are a C₁-C₂₀ alkyl.

2. A method of preparing the conjugated polymer based on perylene tetracarboxylic acid diimide and dibenzothiophene, comprising the following steps:
S11: mixing and dissolving perylene tetracarboxylic acid diimide dibromide or its derivatives and an organic tin compound containing a dibenzothiophene unit in an organic solvent at a molar ratio of 1:1 to 1.5:1; and
S12: adding a catalyst to the solution of Step S11 under an anaerobic environment, and performing a Stille coupling reaction at 50° C. to 120° C. for 24 to 72 hours to produce a solution of the conjugated polymer, with a reaction equation thereof as follows:

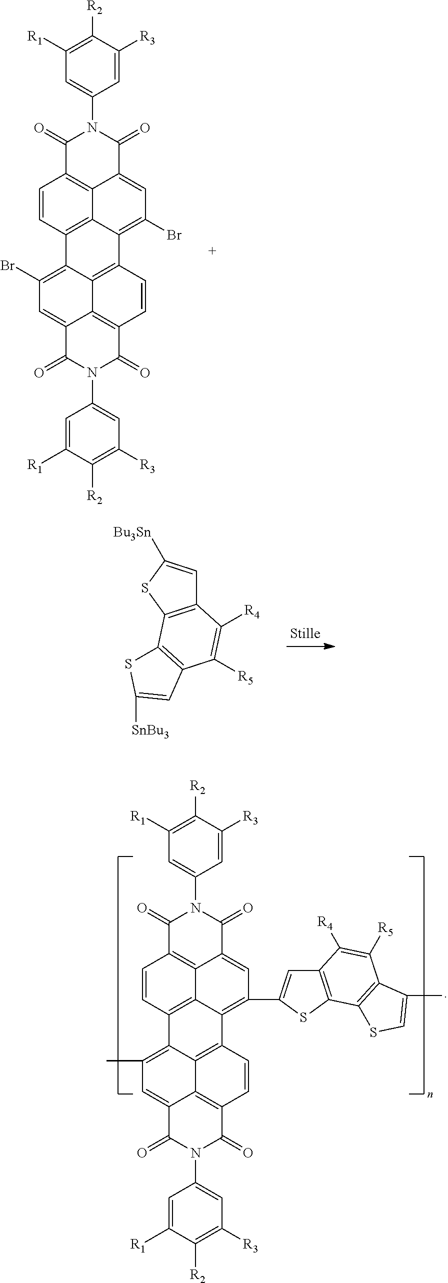

3. The method of preparing the conjugated polymer according to claim 2, wherein the organic solvent in Step S11 is selected from the group consisting of tetrahydrofuran, dimethyl amide, dioxane, ethylene glycol dimethyl ether, benzene, and toluene.

4. The method of preparing the conjugated polymer according to claim 2, wherein the catalyst in Step S12 is added in an amount from 0.01% to 5% by molar number of the total materials;
the catalyst is an organic palladium or a mixture of the organic palladium and an organophosphine ligand;
the organic palladium is selected from the group consisting of Pd₂(dba)₃, Pd(PPh₃)₄ and Pd(PPh₃)₂Cl₂;
the organophosphine ligand is P(o-Tol)₃; and
a molar ratio of the organic palladium to the organophosphine ligand is from 1:2 to 1:20 in the mixture of the organic palladium and the organophosphine ligand.

5. The method of preparing the conjugated polymer according to claim 2, further comprising a purification process after the conjugated polymer solution is obtained, the purification process comprising the following specific steps:
S13: adding the conjugated polymer solution in droplets into methanol for precipitation treatment, and then filtered, washed with methanol and dried, producing a colloid containing the conjugated polymer;
S14: dissolving the colloid containing the conjugated polymer in toluene, then adding the toluene solution into an aqueous solution of sodium diethyldithiocarbamate, and then the resultant solution goes through an aluminum oxide column chromatography after heat agitation at 80° C. to 100° C. to isolate the conjugated polymer, and finally decompression is performed after chlorobenzene elution to remove the organic solvent; and
S15: repeating Step S13 at least once, and using acetone Soxhlet to extract the conjugated polymer isolated in Step S14 to produce a solid conjugated polymer.

6. A method for the applications of the conjugated polymer according to claim 1 in the manufacture of solar cell devices, organic electroluminescent devices, organic field effect transistors.

7. (canceled)

8. (canceled)

9. (canceled)

10. (canceled)

11. (canceled)
